(19) United States
(12) Patent Application Publication
(10) Pub. No.: US 2016/0303885 A1
(43) Pub. Date: Oct. 20, 2016

(54) METHODS FOR BINDING A BOOK

(71) Applicant: KORE S.P.A., Gassino Torinese (Torino) (IT)

(72) Inventor: Pier Mario Bianco, TORINO (IT)

(73) Assignee: KORE S.p.A., Gassino Torinese (Tori (IT)

(21) Appl. No.: 15/037,065

(22) PCT Filed: Nov. 18, 2014
(86) PCT No.: PCT/IB2014/066125

§ 371 Date: May 17, 2016

(30) Foreign Application Priority Data
Nov. 19, 2013 (IT) TO2013A000934

(51) Int. Cl. B42C 9/00; B42D 3/02; B42D 1/04; B42C 11/00; B42C 5/02

(52) U.S. Cl. CPC B42C 9/0025; B42C 11/00; B42C 5/02; B42D 1/04; B42D 3/02

(57) ABSTRACT

Methods for binding books are provided. In such methods a cover made of a flexible material is provided and a block-book is formed joining a number of signatures and applying glue along the spine of the signatures. The book-block is coupled with the cover, obtaining a bound book. The spine of the bound book is rounded off, in order to give the book an outwardly convex spine. The rounded shape of the spine is maintained for a time interval sufficient to allow drying of the glue within the bound book, and finally the book is trimmed. Books made by such methods are also provided.

The disclosures in Italian patent application No. TO2013A000934 from which this application claims priority, and in the abstract accompanying this application are incorporated herein by reference.

### TECHNICAL FIELD

The present invention relates to a method for binding a book.

### BACKGROUND ART

Methods for binding books are known, such as paperback and hardback binding. For conventional paperback binding, use is made of blocks (signatures) of sheets of folded paper (octavo, duodecimo, sextodecimo, vincesimo-quarto, trigesimo-secundo, depending on how many pages each block contains) which are first aligned before a cover made of card is glued on to the spine of said signatures. Lastly, the cover and the sheets of paper are trimmed on the three free sides by means of a trilateral machine known per se.

There are two types of paperback binding:

cut paperback binding: the signatures are gathered together and cut with a cutter on the folded side so as to allow greater penetration, between the sheets of paper, of the glue which is spread on the side of the signatures that will adhere to the cover. These operations are performed using machinery such as Kolbus and Muller Martini machines, which perform the various steps in sequence by means of a conveyor belt. The glue used is hot met adhesive (melting point 180°, dries in 30 seconds), a fast-drying glue which speeds up the production process. The block of signatures glued to the cover then goes into the trilateral machine which trims the three free sides.

stitched paperback binding: the signatures are sewn with a thread of cotton, linen or synthetic material, before being glued to the cover. This type of binding is more resistant to wear and is preferred for more prestigious books.

The spine of a book bound using this production cycle will necessarily be square.

For more valuable books, hardback binding may be used. In hardback binding, the book-block is prepared according to the steps above, but after the signatures have been gathered together and aligned, sheets folded in two made of thicker paper (endpapers), are added on top of the first signature and under the last signature, said endpapers serving to connect the book-block to a cover made of cardboard, preferably covered with other materials.

Starting with the book-block with the square spine, a special machine called a casing-in machine joins the book-block to the cover.

The casing-in machine, in a manner known per se, performs the following operations:

a) loading of the book-block: the book-block is loaded onto a conveyor belt of the casing-in machine with the spine facing downwards;

b) a bookmark ribbon is applied;

c) the book-block is rotated in order to place it with the spine facing upwards;

d) creation of a “falsely rounded” spine: the casing-in machine exerts an upward pressure from below, causing the book-block to curve, such that the spine is concave while the other side is convex;

e) a reinforcing mull with headbands (the finish normally found at the ends of the book) is applied to the convex spine;

f) casing-in: the cover is attached to the book-block by spreading glue on the endpapers and gluing them to the cardboard cover;

g) pressing and creation of the channel;

h) final collection of books for delivery.

Examples of books bound using this method are dictionaries, valuable books, encyclopedias, etc.

One problem associated with the use of these binding methods is that they only make it possible to obtain books which have, exclusively, a square spine or books which, although they have a curved spine when closed, when open do not make it possible to turn the pages by 360° about the axis of binding (defined longitudinally with respect to the spine of the endpapers glued to the reinforcing mull) because in the binding zone, an open portion of elliptical shape is formed, defined on one side by the cardboard cover and on the other side by the spine of the endpapers glued to the reinforcing mull.

### SUMMARY OF THE INVENTION

An object of the present invention is therefore to provide a book-binding method for obtaining a book with a spine which is rounded when closed and which, when open, makes it possible to turn the pages by 360° about the axis of binding.

The above and other objects are achieved by a book-binding method comprising the steps features defined in claim 1. In summary, the method according to the invention is based on the idea of joining a stitched or cut book-block of paper to a cover made of flexible material and conferring a roundness on the spine before trimming the book. Specific embodiments are described in the dependent claims, the content of which should be understood as being an integral part of the present specification.

### BRIEF DESCRIPTION OF THE DRAWINGS

Further features and advantages of the invention will appear from the detailed description which follows, provided purely by way of non-limiting example, with reference to the accompanying drawings, in which:

FIG. 1 is a block diagram indicating steps in the book-binding method according to the invention;

FIG. 2 is a schematic perspective view of a book produced by a method according to the invention; and

FIGS. 3 to 5 are side views schematically depicting subsequent steps in an embodiment of a method according to the invention.

### DETAILED DESCRIPTION

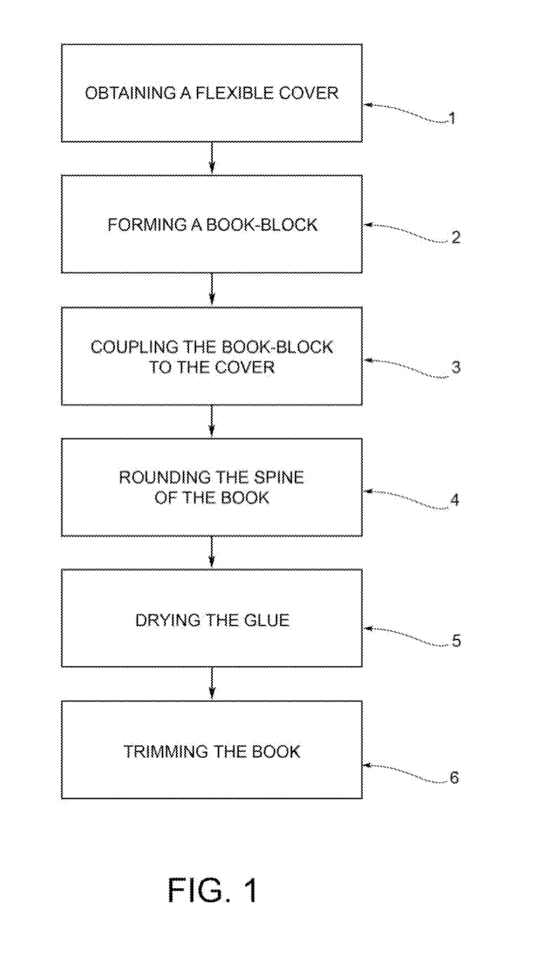

FIG. 1 shows a block diagram of the method according to the invention. As a first operation, in step 1, a flexible cover is made for the book.

To obtain the cover, use is made of a sheet of flexible material, preferably a polyurethane which undergoes a color change when pressed with a hot press (or thermo-tacking polyurethane), known per se. Advantageously, this sheet may be dry-printed (without the use of color) simply by pressing a hot mold on the surface of the sheet. The heat darkens the surface while the pressure leaves an imprint in the material; this results in a bas-relief with the imprinted parts in a darker shade.

As an alternative, it is possible to use sheets of leather, laminated paper, etc. to make the cover.

Preferably, in order to provide a cover which is strong enough while being flexible and easily workable, the cover may be made by juxtaposing and joining two separate sheets of polyurethane, for example sheets of different colors, which are glued together with a glue of known type such as a vinyl adhesive.

The cover thus obtained may then be cut into the desired shapes. At this stage, preferably the cover is cut leaving an excess margin with respect to the desired final format, which will later be trimmed in a final step of the process.

Subsequently, in step 2, a book-block is formed starting from the signatures that have previously been cut or stitched as described above and subsequently coated on the spine with at least a layer, preferably a double layer, of an adhesive having a predetermined intrinsic drying time.

At step 3 the book-block thus prepared with fresh glue is coupled to the cover. Then, the spine of the bound book may be rounded off (step 4) so as to obtain an outwardly convex spine.

In order to round off the spine, the book may for example go into a press roller unit, known per se, which rounds off the spine of the bound book.

After the step of rounding the spine of the bound book, the glue in the bound book is allowed to dry, while maintaining the desired shape of the spine (step 5). Finally, the book is trimmed (step 6).

Depending on the edition of the book, the method may be implemented in two alternative embodiments.

According to a first embodiment of the method, which can be followed for small editions, the drying step may be relatively slow and can take place, for each book, in a mold which maintains the rounded shape of the spine until the glue within the bound book is dry. For small editions, the glue used to couple the spines of the signatures may be for example a vinyl glue, preferably applied in a double layer, having a drying time intrinsic predetermined, for example four hours for air drying (i.e., if a surface to which said glue is applied is allowed to dry in the air, drying takes about 4 hours). Since the spine of the block-book is wrapped in the plastic material of the cover, which prevents perspiration and slows down the evaporation of water in the glue, the glue drying in the bound book is slower as compared to air drying. The time the glue within the bound book takes to dry will therefore be longer than the intrinsic drying time of the glue, for example about 8 to 24 hours. Particularly satisfactory results, in terms of resistance combined with flexibility, have been accomplished with a cold applied glue, commercially available under the name Pastex 150, produced by the company Henkel.

In step 5, the book is then placed in a mold or form suitable for maintaining the rounded shape of the spine and it is left to dry for a time interval sufficient to allow the adhesive in the bound book to dry.

After this time interval, the book is removed from the mold (or form) and is sturdy and flexible, with the spine perfectly curved and outwardly convex, and the cover adhered perfectly to the signatures along the spine.

At this point, in step 6, the book, once removed from the mold, is trimmed using for example a trilateral machine, known per se. Preferably, at this stage the free corners are also rounded.

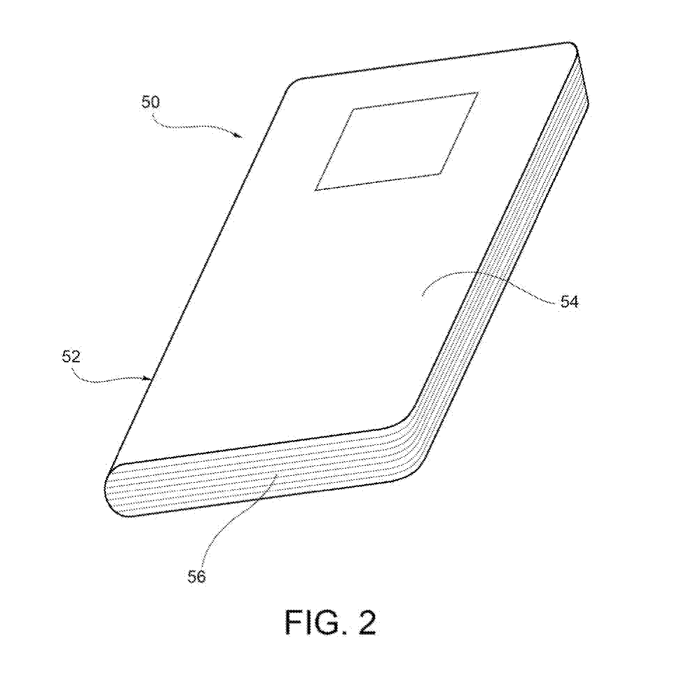

FIG. 2 shows a book 50 obtained using the method according to the present invention. As can be seen, it has a rounded spine 52 and a flexible cover 54 perfectly adhered to the pages 56 of the book 50.

A second embodiment of the method, which can be followed to produce greater editions (for example in the order of 3000-5000 copies/hour), comprises a drying step which is relatively faster and avoids having to place each book in a mold until the glue has dried. According to this variant of the method, the glue that is applied has a relatively shorter intrinsic drying time.

Preferably, the step of drying the glue in the bound book may be performed as the bound book transits through a roller set that gives the spine of the outwardly convex shape and keeps the spine in this form for a time interval sufficient to allow the drying of the glue in the bound book.

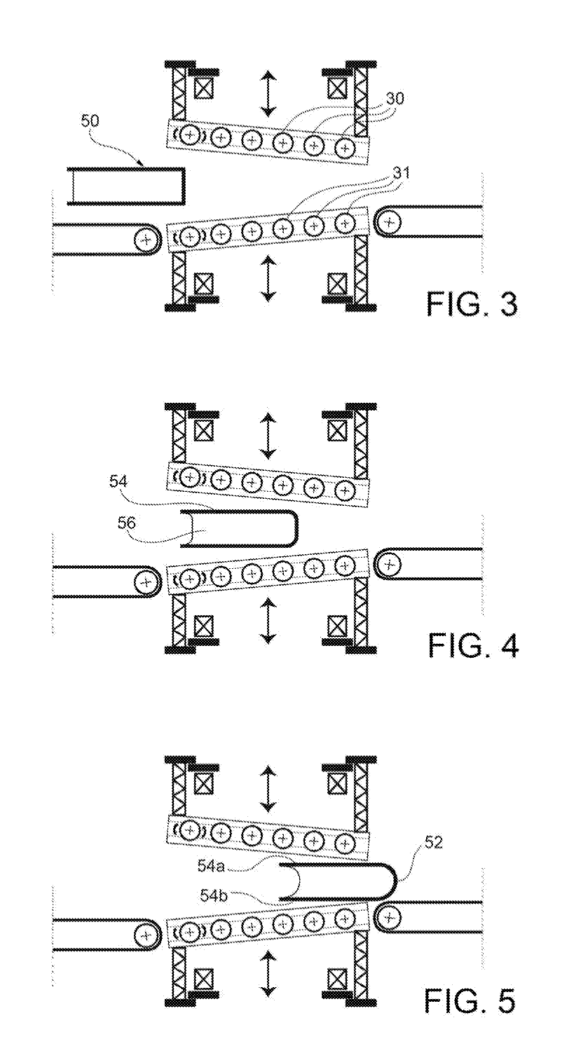

As shown in FIGS. 3 to 5, the rounded shape of the spine is preferably imparted by passing the bound book 50 in a press roller conveyor comprising two series of counter-rotating embossed rollers 30, 31, acting simultaneously against opposite faces 54a and 54b of the cover 54. The rollers 30, 31 define between them a progressively tapered path that causes the advancement of the book and gradually gives roundness to the spine while the glue is not yet dried. Experimental tests have given particularly satisfactory results, in terms of combined resistance, flexibility and speed of drying, with a thermoplastic glue applied hot, for example, a hot-melt adhesive.

The method according to the present invention may be used for producing publishing products of various types (school books, diaries, guidebooks) having as functional features flexibility and the possibility of opening by 180° and 360°.

A number of aspects and embodiments of a method according to the invention for binding a book have been disclosed. It is to be understood that each aspect or embodiment may be combined with any other aspect or embodiment. Moreover the invention is not restricted to the described embodiments, but may be varied within the scope of the accompanying patent claims.

1-8. (canceled)

9. A method for binding a book comprising the steps of:
obtaining a cover made of flexible material;
forming a book-block by joining a plurality of signatures;
applying glue to the spine of said signatures;
coupling the book-block to the cover to obtain a bound book;
rounding off the spine of the bound book to obtain an outwardly convex spine;
maintaining the rounded shape of the spine for a time interval sufficient to allow the glue within the bound book to dry; and
trimming the book.

10. The method of claim 9, wherein the step of obtaining a cover made of flexible material comprises the step of superimposing and joining two separate sheets of flexible material by gluing.

11. The method of claim 10, wherein the two sheets comprise thermo-tracking polyurethane.

12. The method of claim 9, wherein the step of maintaining the rounded shape of the spine for a time interval sufficient to allow the drying of the glue in the bound book includes the step of positioning the bound book in a mold adapted to maintain the rounded shape of the spine.

13. The method of claim 9, wherein the step of applying glue to the spine of said signatures comprises cold application of at least one layer of vinyl glue.

14. The method of claim 13, wherein the step of applying glue to the spine of said signatures comprises cold application of two layers of vinyl glue.

15. The method of claim 9, wherein
the step of applying glue to the spine of said signatures comprises heat application of at least one layer of thermoplastic glue, and wherein
the step of maintaining the rounded shape of the spine for a time interval sufficient to allow the drying of the glue in the bound book comprises passing the bound book in a press roller conveyor comprising two sets of counter-rotating rollers acting simultaneously against two opposite faces of the cover, wherein the two sets of rollers cause the advancement of the book and gradually give roundness to the spine of the book while the glue is not yet dried.

16. A book bound through the binding method of claim 9.
